(19) United States
(12) Patent Application Publication
(10) Pub. No.: US 2015/0257102 A1
(43) Pub. Date: Sep. 10, 2015

(54) MOBILE COMMUNICATION TERMINAL AND CONTROL METHOD

(71) Applicant: KYOCERA CORPORATION, Kyoto (JP)

(72) Inventor: Atsuhiko KANDA, Osaka (JP)

(73) Assignee: KYOCERA CORPORATION, Kyoto (JP)

(21) Appl. No.: 14/716,707

(22) Filed: May 19, 2015

Related U.S. Application Data
(63) Continuation of application No. 13/403,894, filed on Feb. 23, 2012.

(30) Foreign Application Priority Data
Feb. 24, 2011 (JP) 2011-038933

(51) Int. Cl. H04W 52/02; H04W 48/16

(52) U.S. Cl. CPC H04W 52/0225; H04W 48/16

(57) ABSTRACT

A mobile communication terminal that receives a signal from a plurality of access points and performs a wireless communication using any one of the plurality of access points, includes: a scanning unit configured to perform a scanning periodically to receive a signal including an identifier from respective access points; and a controller configured to compare a plurality of first identifiers received by a first scanning by the scanning unit with a plurality of previous identifiers received by a previous scanning performed before the first scanning, wherein, when a number of first identifiers which are identical to any of the previous identifiers is a predetermined number or more, the controller sets a specific period, as a period from the first scanning to a second scanning performed after the first scanning, to be longer than a previous period from the previous scanning to the first scanning.

### CROSS-REFERENCE TO RELATED APPLICATION

This application is a Continuation of U.S. patent application Ser. No. 13/403,894 filed on Feb. 23, 2012, which claims priority from Japanese Patent Application No. 2011-038933 filed on Feb. 24, 2011, the entire subject matter of which is incorporated herein by reference.

### TECHNICAL FIELD

This disclosure relates to a mobile communication terminal that performs wireless communication and, more specifically, to reduce the power consumption caused by an access point scanning.

### BACKGROUND

It is known that a mobile communication terminal scans an access point periodically for wireless communication. For example, a mobile communication terminal disclosed in JP-A-2008-066892 calculates a difference between a signal strength received at previous time from an access point that is currently in use and a signal strength received at present time from the same, when scanning the access point. When the calculated difference between the strengths is larger than a predetermined value, it is determined that the user of the communication terminal is moving at a high speed which is not suitable for wireless communication, and thus a scan cycle is adjusted to be increased. In contrast, when the difference is equal to or less than a predetermined value, it is determined that the user of the communication terminal is moving at a low speed which is suitable for wireless communication and the scanning cycle is adjusted to be shortened.

### SUMMARY

However, in the technique disclosed in JP-A-2008-066892, it is possible to reduce the power consumption caused by scanning the access point that is moving at a high speed which is not suitable for the wireless communication, but it is not possible to reduce the power consumption caused by scanning for the access point that is not moving at a high speed.

This disclosure provides at least a mobile communication terminal capable of reducing power consumption caused by scanning an access point when the user of the communication terminal is not moving at the high speed.

In view of the above, in one aspect of this disclosure, a mobile communication terminal receives a signal from a plurality of access points and performs a wireless communication using any one of the plurality of access points, and the mobile communication terminal comprises: a scanning unit configured to perform a scanning periodically to receive a signal including an identifier from respective access points; and a controller configured to compare a plurality of first identifiers received by a first scanning by the scanning unit with a plurality of previous identifiers received by a previous scanning performed before the first scanning, wherein, when a number of first identifiers which are identical to any of the previous identifiers is a predetermined number or more, the controller sets a specific period, as a period from the first scanning to a second scanning performed after the first scanning, to be longer than a previous period from the previous scanning to the first scanning.

In the above-described mobile communication terminal, the scanning unit may obtain a strength of the signal received from the respective access points, the scanning unit may includes a list creating unit configured to associate the identifiers with the strengths, respectively, and to create a list including the identifiers sorted in an order of the strengths, and the controller may a first list created by the list creating unit based on the first scanning result with a previous list created based on the previous scanning result. When a number of orders of the identified first identifiers in the first list which are identical to orders of the identified previous identifiers in the previous list is a predetermined number or more, the controller may sets the specific period from the first scanning to the second scanning to be longer than the previous period from the previous scanning to the first scanning.

In the above-described mobile communication terminal, when a number of orders of the identified first identifiers in the first list which are identical to orders of the identified previous identifiers in the previous list is the predetermined number or more, if the specific period is to be longer than a upper limit period, the controller may set the upper limit period as the specific period

In another aspect of this disclosure, a mobile communication terminal receives a signal from a plurality of access points and performs a wireless communication using any one of the plurality of access points, and a mobile communication terminal comprises: a scanning unit configured to perform a scanning periodically to receive the signal including an identifier from the respective access points; and a controller configured to compare a plurality of nₜₕ identifiers received on the nₜₕ (n>1) scanning by the scanning unit with a plurality of (n−k)ₜₕ identifiers received on the (n−k)ₜₕ (n>k≧1) scanning, wherein when the number of nₜₕ identifiers which are identical to any of the (n−k)ₜₕ identifiers is a predetermined number or more, the controller set a specific period, as a period from an nₜₕ scanning to an (n+1)ₜₕ scanning, to be longer than a period from an (n−k)ₜₕ scanning to an (n−k+1)ₜₕ scanning.

In the above-described mobile communication terminal, the scanning unit may detect a strength of the signal received from the access point, the scanning unit may include a list creating unit configured to associate the identifiers with the strengths, respectively, and to create a list including the identifiers sorted in an order of the strengths, the controller may compare an nₜₕ list created by the list creating unit based on the nₜₕ (n>1) scanning result with an (n−k)ₜₕ list created based on the (n−k)ₜₕ (n>k≧1) scanning result. When a number of orders of the identified nₜₕ identifiers in the nₜₕ list which are identical to orders of the identified (n−k)ₜₕ identifiers in the (n−k)ₜₕ list is a predetermined number or more, the controller may set the specific period from the nₜₕ scanning to the (n+1)ₜₕ scanning to be longer than the period from the (n−k)ₜₕ scanning to the (n−k+1)ₜₕ scanning.

In the above-described mobile communication terminal, when a number of orders of the identified nₜₕ identifiers in the nₜₕ list which are identical to orders of the identified (n−k)ₜₕ identifiers in the (n−k)ₜₕ list is the predetermined number or more, if the specific period is to be longer than a upper limit period, the controller may set the upper limit period as the specific period.

In the above-described mobile communication terminal, when a number of orders of the identified first identifiers in the first list which are identical to orders of the identified previous identifiers in the previous list is less than the predetermined number, the controller may set an initial value as the specific period.

In the above-described mobile communication terminal, the list creating unit may create the list including only access points, of which a strength of a signal is a predetermined strength or more.

In the above-described mobile communication terminal, the scanning unit may obtain a strength of the signal received from the access point, the scanning unit may include a list creating unit configured to associate the identifiers with the strengths, respectively, and to create a list including the identifiers sorted in an order of the strengths, and the controller may compare a first list created by the list creating unit based on the first scanning result with a previous list created based on previous scanning results before the first scanning. When a number of orders of the identified first identifiers in the first list which are identical to orders of the identified previous identifiers in the previous list is a predetermined number or more and when a difference between the strengths of the first identifiers on the first scanning and the strengths of the previous identifiers, which are identified to any of the first identifiers, on the previous scanning is within a predetermined range, the controller sets the specific period from the first scanning to the second scanning to be longer than the previous period from the previous scanning to the first scanning.

In the above-described mobile communication terminal, the scanning unit may detect a strength of the signal received from the access point, the scanning unit may include a list creating unit configured to associate the identifiers with the strengths, respectively, and to create a list in which the identifiers are sorted in an order of the strengths, and the controller may compare a list created by the list creating unit based on the nₜₕ (n>1) scanning result with a list created based on the (n−k)ₜₕ (n>k≧1) scanning result. When a number of orders of the identified nₜₕ identifiers in the nₜₕ list which are identical to orders of the identified (n−k)ₜₕ identifiers in the (n−k)ₜₕ list is a predetermined number or more, and when a difference between the strengths of the nₜₕ identifiers on the nₜₕ scanning and the strengths of the (n−k)ₜₕ identifier, which are identified to any of the nₜₕ identifiers, on the previous scanning is within a predetermined range, the controller sets the specific period from the nₜₕ scanning to the (n+1)ₜₕ scanning to be longer than the period from the (n−k)ₜₕ scanning to the (n−k+1)ₜₕ scanning.

With the above-mentioned configuration, the mobile communication terminal according to this disclosure may reduce the power consumption caused by scanning an access point.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a view illustrating a functional configuration of a mobile communication terminal according to an illustrative embodiment of this disclosure;

FIG. 2 is a timing chart illustrating an operation of the mobile communication terminal;

FIGS. 3A to 3E are views illustrating examples of configuration data items and its contents of lists;

FIG. 4 is a flow chart illustrating an operation of the mobile communication terminal; and

FIG. 5 is a flow chart illustrating details of a determination process.

### DETAILED DESCRIPTION

### Illustrative Embodiment

Hereinafter, a mobile communication terminal 100 according to an illustrative embodiment of this disclosure will be described.

### <Outline>

The mobile communication terminal 100 repeats a scanning period, during which the terminal receives a signal including an access point identifier (SSID: service set identifier) from an access point to perform wireless communication, and a waiting period, during which the terminal waits until the next scanning begins.

The mobile communication terminal 100 receives signals from respective access points at a scan period Ts of a predetermined cycle Cₙ for example an nₜₕ cycle Cₙ in this illustrative embodiment, and detects the SSID and a strength to prepare a list in which the SSID is associated with the strength for each access point. Thereafter, by comparing a list created at the cycle Cₙ with a list created at a cycle Cₙ₊₁, when it is determined that both lists are corresponded with each other enough to satisfy a predetermined criterion, for example a relative position of the user of the communication terminal and the access point is scarcely changed or the user is scarcely moving, the waiting period Tₙ at the cycle Cₙ is set to be longer than a waiting period Tₙ₋₁ at the cycle Cₙ₋₁, thereby lengthening a scanning interval. In contrast, when it is determined that both lists are not corresponded with each other, for example the relative position of the user and the access point is changed or the user is moving, a initial value (hereinafter, referred to as a “lower limit” in this illustrative embodiment, because the initial value corresponds to the shortest period as a waiting period) is set in advance as the waiting period Tₙ.

Therefore, when it is determined that the user is scarcely moving, then the scanning interval is set to be longer to reduce the power consumption, and when it is determined that the user is moving, then the scanning interval is set to be shorter to seamlessly perform wireless communication even when the user is moving.

### <Configuration>

Hereinafter, a configuration of the mobile communication terminal 100 will be described.

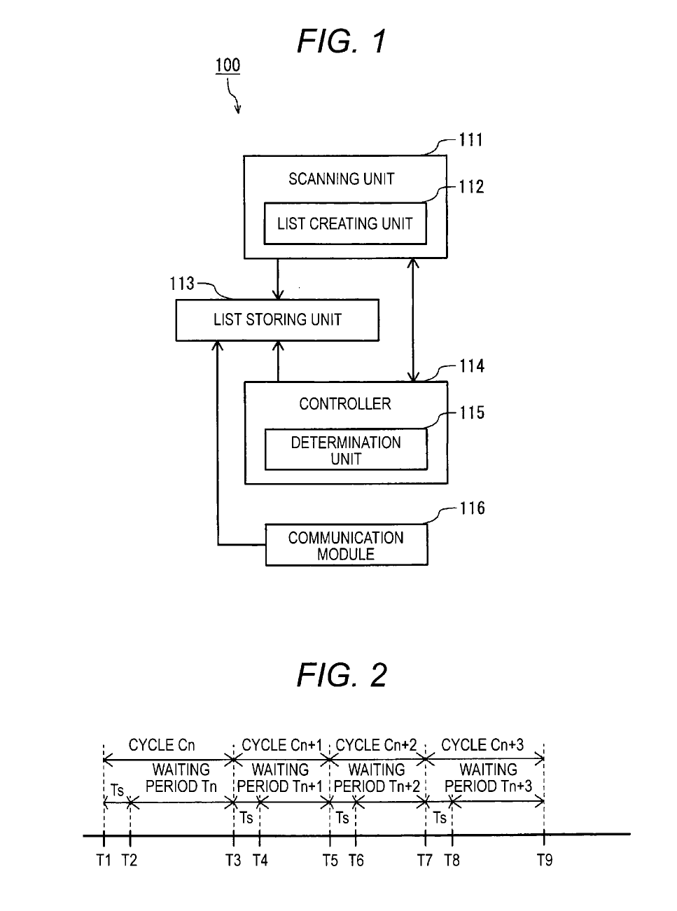

FIG. 1 is a view illustrating a configuration of the mobile communication terminal 100. The mobile communication terminal 100 performs wireless communication using an access point. As shown in FIG. 1, the mobile communication terminal 100 includes a scanning unit 111, a list storing unit 113, a controller 114, and a communication module 116. The mobile communication terminal 100 includes a processor and a memory. The respective functions of the scanning unit 111 and the controller 114 are performed by executing programs stored in the above-mentioned memory by the above-mentioned processor.

The scanning unit 111 is configured to scan an access point. Here, the scanning unit 111 tries to continuously receive a signal from the end of the predetermined frequency band in a predetermined frequency band, and thus the scanning unit 111 receives a signal that is within the frequency band and broadcasted periodically from the access point. The scanning unit 111 includes an amplifier (not shown) and amplifies the received signal using the amplifier to detect the SSID and the signal strength.

The scanning unit 111 further includes a list creating unit 112. The list creating unit 112 is configured to associate the SSIDs with the signal strengths respectively for each access point, from which the scanning unit 111 receives the signal, so that the list creating unit creates a list L (which will be described below) in which the access points are sorted in a descending order of the signal strengths. Here, the communication module 116 has a function to perform wireless communication using an access point having a predetermined signal strength value or more based on the scanning result from the scanning unit 111. A distance of the signal transmitted from the access point has a limitation, and the user of the communication terminal may perform wireless communication while moving. Therefore, the scanning unit 111 is required to scan periodically the access point. Hereinafter, it is assumed in the following description that a list Lₙ is created by the list creating unit 112 at nₜₕ scan cycle Cₙ, and a waiting period at the cycle Cₙ is a waiting period Tₙ.

The list storing unit 113 is a memory area that stores the list L created by the list creating unit 112. When the list creating unit 112 creates the list L, the created list L is stored in the list storing unit 113. The list storing unit 113 stores two lists L. When the list creating unit 112 creates a list Lₙ₊₁ to be stored in the list storing unit 113 when the lists Lₙ₋₁ and Lₙ are stored in the list storing unit 113, the list Lₙ₋₁ is overwritten by the list Lₙ₊₁.

FIG. 2 is a timing chart illustrating an operation of the mobile communication terminal 100. In FIG. 2, the period from a time point T1 to a time point T3 indicates an nₜₕ scan cycle Cₙ. The period from the time point T1 to a time point T2 indicates a scan period Ts, during which the mobile communication terminal 100 scans the access points at the cycle Cₙ. At the time point T2 when the scanning is completed, the list creating unit 112 creates a list Lₙ, in which the signals are sorted in the descending order of the signal strength with associating the SSID with the strength respectively for each access point from which a signal is received. Thereafter, the created list Lₙ is compared with the list Lₙ₋₁ created at the cycle Cₙ₋₁ to perform the determination process, which will be described. According to the result of the determination process, a waiting period Tₙ until the next scanning begins is determined. Such process as above is performed in the scan period Tₛ.

The period from the time point T2 to the time point T3 indicates the waiting period Tₙ at the cycle Cₙ. In the meantime, when the wireless communication could not be performed using an access point scanned at the time of wireless communication, the access point scanning is performed again. The controller 114 further includes a determination unit 115 and controls a scan cycle, during which the scanning unit 111 scans the access points, in accordance with the result of the determination process (which will be described below) of the determination unit 115.

The determination unit 115 compares the list Lₙ₋₁ and the list Lₙ created by the list creating unit 112 at the cycle Cₙ to determine whether both lists are corresponded with each other enough to satisfy a predetermined criterion. Here, when a first identifier of the respective lists are corresponded with each other and the signal strength in the list Lₙ is within a predetermined range (for example, within ±10%) from the signal strength in the list Lₙ₋₁, it is determined that first access points of the lists are corresponded with each other. When three access points in order from the first access point are corresponded with each other, it is determined that both lists are corresponded with each other enough to satisfy a predetermined criterion.

When the determination unit 115 determines that both lists are corresponded with each other enough to satisfy the predetermined criterion, the controller 114 sets a value obtained by adding a predetermined additional value ΔT (for example, 10 seconds) to the waiting period Tₙ₋₁ as a waiting period Tₙ. When the determination unit determines that the both lists are not corresponded with each other, the controller 114 sets a lower limit (for example, 60 seconds) as the waiting period Tₙ. The controller 114 includes a timer (not shown) and sends a command to initiate scanning to the scanning unit 111 after the waiting period T set in the timer is elapsed. In the meantime, an upper limit (for example, 180 seconds) is set in advance in the waiting period T. Therefore, even though the both lists are corresponded with each other enough to satisfy the predetermined criterion, the controller 114 does not set as a period longer than the upper limit as a waiting period T.

### <Data>

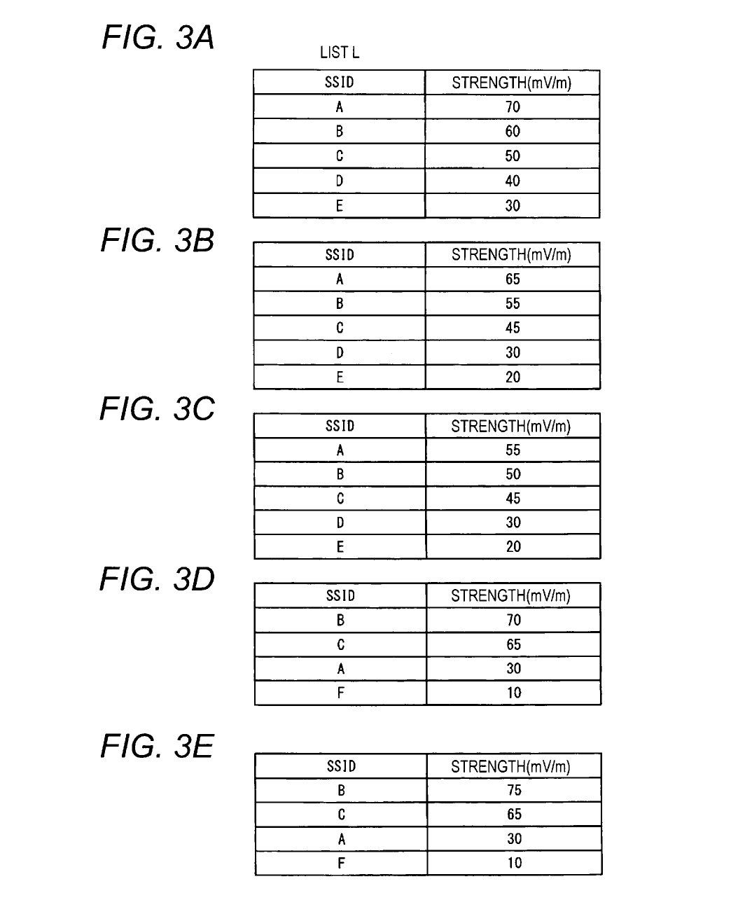

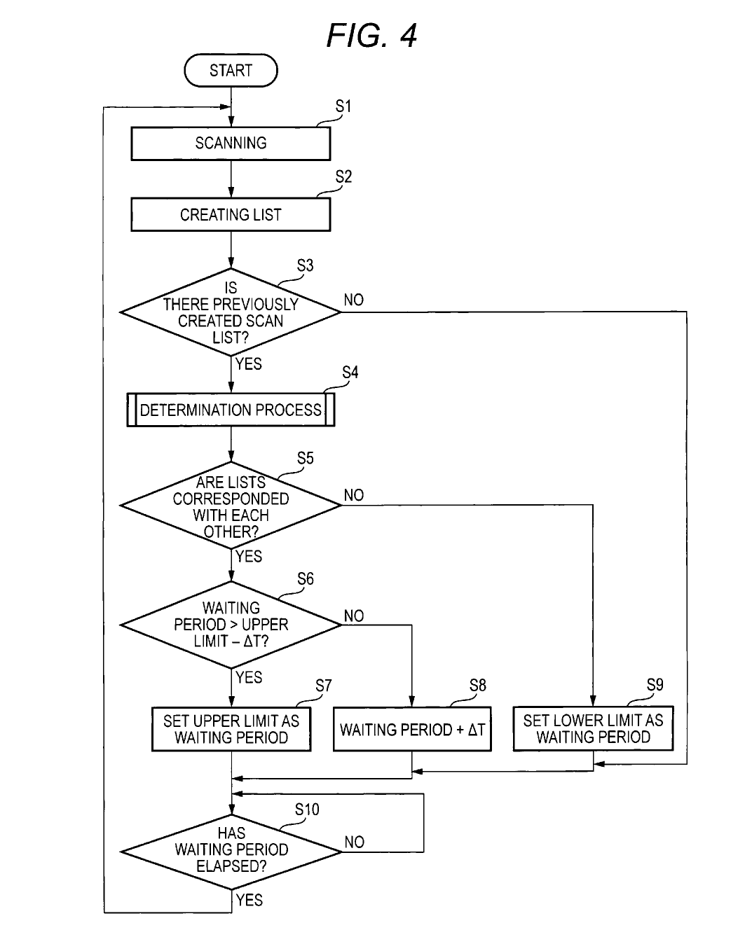

FIGS. 3A to 3E illustrate examples of the configuration data items and its contents of the lists L. The list L is information, in which signal strengths are respectively associated with the SSIDs and sorted in a descending order of the signal strengths. In the figures, the unit of the strength of the signal is represented by mV/m. The list Lₙ created at the scan cycle Cₙ is created based on the SSID and the strength of the signal received by the scanning unit 111 at the cycle Cₙ. The list Lₙ is used for the determination processes at the cycles Cₙ and Cₙ₊₁.

### <Operation>

Hereinafter, operations of the mobile communication terminal 100 will be described. FIG. 4 is a flowchart illustrating the operations of the mobile communication terminal 100. As shown in FIG. 4, the scanning unit 111 of the mobile communication terminal 100 scans access points at the cycle Cₙ (step S1). Here, the scanning unit 111 receives a signal including an SSID from an access point to detect the SSID of the access point and a strength of the received signal. Subsequently, the list creating unit 112 associates the strength of the received signal with the SSID respectively for each access point, from which the scanning unit 111 receives the signal, creates a list Lₙ sorted in a descending order of the strengths of the signals, and stores the list in the list storing unit 113 (step S2). The controller 114 determines whether the list Lₙ₋₁ exists (step S3). When the list Lₙ₋₁ exists, the determination unit 115 performs the determination process to determine whether the list Lₙ and the list Lₙ₋₁ are corresponded with each other enough to satisfy a predetermined criterion (step S4). The determination process will be described in detail below.

When the determination unit 115 determines that the both lists are corresponded with each other enough to satisfy the predetermined criterion (“Yes” at step S5), the controller 114 determines whether the waiting period Tₙ₋₁ is larger than a value obtained by subtracting the additional value ΔT (for example, 10 seconds) from a predetermined upper limit (for example, 180 seconds). When the value is larger than the predetermined upper limit (“Yes” at step S6), the upper limit is set as the waiting period Tₙ (step S7). When the value is not larger than the predetermined upper limit (“No” at step S6), the value obtained by adding the additional value ΔT to the waiting period Tₙ₋₁ is set as the waiting period Tₙ (step S8).

When the determination unit 115 determines that the both lists are not corresponded with each other enough to satisfy the predetermined criterion (“No” at step S5), the controller 114 sets the lower limit (for example, 60 seconds) as the waiting period Tₙ (step S9). In the meantime, when the list Lₙ₋₁ does not exist (“No” at step S3), the controller 114 does not change the waiting period Tₙ so that the waiting period Tₙ becomes the same period as the waiting period Tₙ₋₁.

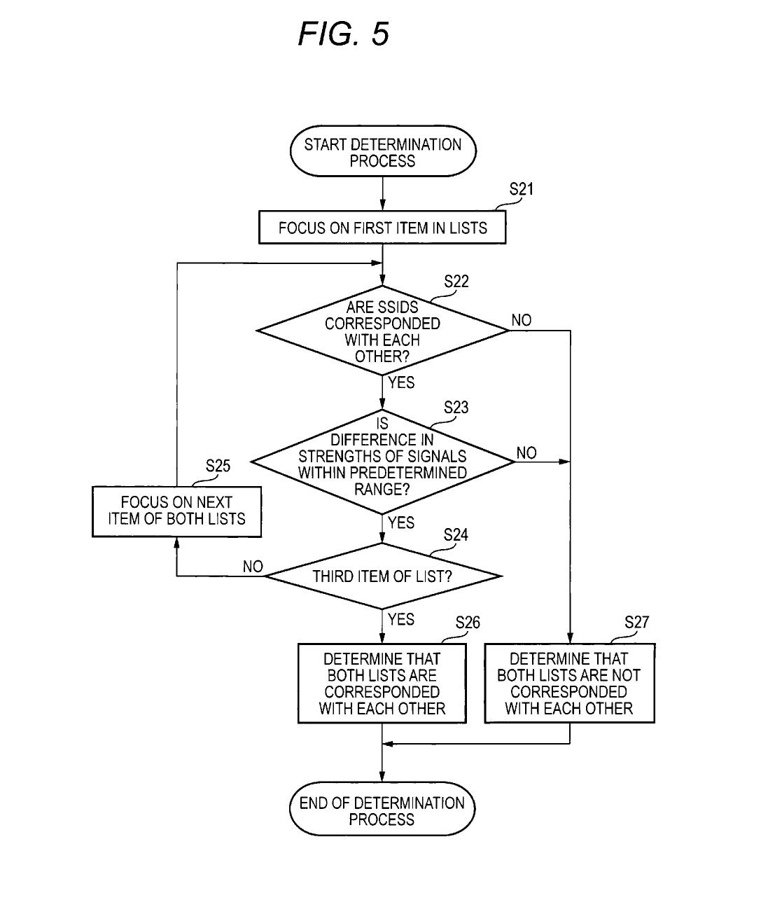

After elapsing the waiting period Tₙ (“Yes” at step S10), the scanning unit 111 repeats the steps S1 through S10. Hereinafter, details of the determination process at step S4 will be described with reference to FIG. 5. The determination unit 115 focuses on first SSIDs of the lists Lₙ and Lₙ₋₁, that is, SSIDs having the highest signal strength in the lists (step S21), and then determines whether the first SSIDs of the list Lₙ and that of the list Lₙ₋₁ are corresponded with each other (step S22). When the SSIDs are corresponded with each other, it is determined whether a signal strength associated with an SSID of a target list Lₙ is within a predetermined range from a signal strength associated with the SSID of the list Lₙ₋₁ (for example, within ±10%) (step S23). When it is determined that the strength is within a predetermined range, it is determined that the access points are corresponded with each other, and then the determination unit 115 focuses on next SSIDs of the lists (step S25). Similarly to the above determination process, it is determined whether the SSIDs are corresponded with each other and the difference between their signal strength is within a predetermined range. When three access points in order from the first access points of the lists are corresponded with each other (“Yes” at step S24), the determination unit 115 determines that the lists are corresponded with each other enough to satisfy a predetermined criterion (step S26).

Any one of the three access points in order from the first access points of the lists are not corresponded with each other (“No” at step S22 and “No” at step S23), it is determined that the lists are not corresponded with each other (step S27). By performing the determination process as described above, when it is assumed that the user scarcely moves, the interval of scanning is set to be longer to reduce the power consumption. When, however, it is assumed that the user moves, the scanning is performed at a shorter interval so that seamless wireless communication is achieved even during the user is moving. Further, when the three access points in order from the first access points in both lists are corresponded with each other, it is determined in this case that the both lists are corresponded with each other. Therefore, even when the user scarcely moves and but only a signal having a relatively weak strength can not received due to the surrounding environment such as persons or cars, it is possible to suppress the scan period from being shortened.

Hereinafter, a specific example of operation of the mobile communication terminal 100 will be described with reference to FIGS. 2 and 3. It is assumed that the user is performing wireless communication using the mobile communication terminal 100 while not moving before the time point T1, and starts to move at the time point T2 and stops at the time point T5. It is assumed in the following description that the list Lₙ₋₁ represents a status shown in FIG. 3A, a waiting period Tₙ₋₁ is 100 seconds, a lower limit of the waiting period T is 60 seconds, and an additional value ΔT is 10 seconds.

The scanning unit 111 scans an access point between the time point T1 and the time point T2. When a list Lₙ that is created by the list creating unit 112 based on the scanning result at the time point T2 is in a status shown in FIG. 3B, the first access points of the respective lists Lₙ and Lₙ₋₁ are determined that the SSIDs are corresponded with each other and the strength of 65 mV/m in the list Ln is within ±10% from the strength of 70 mV/m in the list Lₙ₋₁. Accordingly, it is determined that the first access points in the lists are corresponded with each other. Similarly, since the second and third access points of the lists are also corresponded with each other, the determination unit 115 determines that the lists are corresponded with each other enough to satisfy a predetermined criterion, and the controller 115 sets 110 seconds as the waiting period Tₙ.

After elapsing of the waiting period Tₙ, the scanning unit 111 scans an access point between the time point T3 and the time point T4. When a list Lₙ₊₁ that is created by the list creating unit 112 based on the scanning result at the time point T4 was in a status shown in FIG. 3C, the first access points of the lists are determined that the SSIDs are corresponded with each other, and but the strength of 55 mV/m in the list Lₙ₊₁ is not within ±10% from the strength of 65 mV/m in the list Lₙ. Accordingly, it is determined that the first access points in the lists Lₙ and Lₙ₊₁ are not corresponded with each other. Therefore, the determination unit 115 determines that the lists are not corresponded with each other and the controller 114 sets 60 seconds as the waiting period Tₙ₊₁.

After elapsing of the waiting period T_{n+1,} the scanning unit 111 scans an access point between the time point T5 and the time point T6. When a list Lₙ₊₂ that is created by the list creating unit 112 based on the scanning result at the time point T6 was in a status shown in FIG. 3D, the first access points of the lists Lₙ₊₁ and Lₙ₊₂ are determined that the SSIDs are not corresponded with each other. Accordingly, the determination unit 115 determines that the lists are not corresponded with each other and the controller 114 sets 60 seconds as the waiting period Tₙ₊₂.

After elapsing of the waiting period T_{n+2,} the scanning unit 111 scans an access point between the time point T7 and the time point T8. When a list Lₙ₊₃ that is created by the list creating unit 112 based on the scanning result at the time point T8 was in a status shown in FIG. 3E, it is determined that three access points in order from first access points in the list Lₙ₊₂ and the list Lₙ₊₃ are corresponded with each other and differences are within ±10%. Accordingly, the determination unit 115 determines that the lists are corresponded with each other enough to satisfy a predetermined criterion, and the controller 114 sets 70 seconds as the waiting period Tₙ₊₃.

### <Modification>

Though the illustrative embodiments of the mobile communication terminal according to this disclosure are described above, this disclosure is not limited thereto but may be modified as follows.

(1) In the above-mentioned illustrative embodiment, the upper limit of the waiting period T is set. However, the waiting period T may be continuously extended without setting its upper limit as long as the lists are corresponded with each other.

(2) In the above-mentioned illustrative embodiment, when the lists are corresponded with each other enough to satisfy the predetermined criterion, the waiting period T is gradually extended by adding the addition value ΔT to the waiting period T. However, when the lists are corresponded with each other enough to satisfy the predetermined criterion, the upper limit may be set as the waiting period T, and when the lists are not corresponded with each other enough to satisfy the predetermined criterion, the lower limit may be set as the waiting period T.

(3) In the above-mentioned illustrative embodiment, when comparing the lists Lₙ and Lₙ₋₁ and the SSIDs are corresponded with each other and a signal strength associated with the SSID of the list Lₙ is within a predetermined range from a signal strength associated with the SSID of the list Lₙ₋₁, it is determined that the access points are corresponded with each other. However, when the SSIDs are corresponded with each other but the signal strength associated with the SSIDs is not within the predetermined range, it may also be determined that the access points of the lists are corresponded with each other.

(4) In the above-mentioned illustrative embodiment, when three access points in order from the first access points are corresponded with each other in the lists, in which access points are sorted in a descending order of the signal strengths based on the received signal, it is determined that the lists are corresponded with each other enough to satisfy a predetermined criterion. However, the predetermined criterion is not limited to determine whether the three access points are corresponded with each other. The other predetermined criterion may be adopted as long as the change in the relative position between mobile communication terminal and the access point can be determined, and the number of the corresponding identifiers corresponding with each other may be detected from the received signal for each scanning regardless of the sorted order of the signal strengths. The predetermined number of the access points may be not fixed. When a rate of access points corresponded with each other is equal to or larger than a rate representing a predetermined rate of the access points in the lists, it may be determined that the lists are corresponded with each other enough to satisfy the predetermined criterion. Specifically, for example, in case that the predetermined rate is 40%, when two or more access points detected from the signals are corresponded with two of listed five access points, or when eight or more access points detected from the signals are corresponded with eight of listed twenty access points, it is determined that the lists are corresponded with each other enough to satisfy the predetermined criterion.

(5) In the above-mentioned illustrative embodiment, the list Lₙ is created using all signals received at the cycle Cₙ. However, the list Lₙ may be created using only signals, of which the signal strengths have a predetermined value or higher, among the received signals. Here, the predetermined value of signal strength may identical to a signal strength determined as the signal strength capable of the wireless communication using the access point.

(6) In the above-mentioned illustrative embodiment, it is determined that the lists are corresponded with each other enough to satisfy the predetermined criterion by comparing the list Lₙ and the list Lₙ₋₁. However, this disclosure is not limited thereto. The list Lₙ may be compared with a list that was previously created within a passed time. For example, it may be determined that the lists are corresponded with each other enough to satisfy the predetermined criterion by comparing the lists Lₙ and Lₙ₋₂. When it is determined that the list Lₙ and the list Lₙ₋₂ are corresponded with each other enough to satisfy the predetermined criterion when comparing the lists Lₙ and Lₙ₋₂, the waiting period Tₙ is set to be longer than the waiting period Tₙ₋₂. The number of scanning result to be compared with the nₜₕ scanning result is not limited to only one, and the nₜₕ scanning result may be compared with a plurality of scanning results from scanning performed before nₜₕ scanning.

(7) The above-mentioned described illustrative embodiments and the modified examples may be partially combined with each other.

(8) In the above-mentioned illustrative embodiment, the mobile communication terminal is described above as one illustrative embodiment of this disclosure. However, this disclosure is not limited thereto. This disclosure may be applied to a control method or an non-transitory computer-readable medium to control a mobile communication terminal to perform the control method.

Accordingly, the mobile communication terminal according to the illustrative embodiment of this disclosure may reduce the power consumption caused by the access point scanning and is useful for a wireless communication terminal.

What is claimed is:

1. A mobile communication terminal that receives a signal from a plurality of access points and performs a wireless communication using any one of the plurality of access points, comprising:
a scanning unit configured to perform a scanning periodically to receive a signal including an identifier from respective access points; and
a controller configured to compare a set of two or more first identifiers received by a first scanning by the scanning unit with a set of two or more previous identifiers received by a previous scanning performed before the first scanning,
wherein,
when at least a predetermined number of first identifiers are included among the set of previous identifiers while the set of first identifiers is not the same as the set of previous identifiers, the controller sets a specific period, as a period from the first scanning to a second scanning performed after the first scanning, to be longer than a previous period from the previous scanning to the first scanning.

2. The mobile communication terminal of claim 1,
wherein, when a number of orders of the identified first identifiers in the first list which are identical to orders of the identified previous identifiers in the previous list is the predetermined number or more, if the specific period is to be longer than a upper limit period, the controller sets the upper limit period as the specific period.

3. A mobile communication terminal that receives a signal from a plurality of access points and performs a wireless communication using any one of the plurality of access points, comprising:
a scanning unit configured to perform a scanning periodically to receive the signal including an identifier from the respective access points; and
a controller configured to compare a set of two or more of nth identifiers received on the nth (n>1) scanning by the scanning unit with a set of two or more (n−k)th identifiers received on the (n−k)th (n>k≧1) scanning,
wherein
when at least a predetermined number of nth identifiers are included among the set of (n−k)th identifiers while the set of nth identifiers is not the same as the set of (n−k)th identifiers, the controller sets a specific period, as a period from the first scanning to a second scanning performed after the first scanning, to be longer than a previous period from the previous scanning to the first scanning.

4. The mobile communication terminal of claim 3,
wherein the scanning unit detects a strength of the signal received from the access point,
wherein the scanning unit includes a list creating unit configured to associate the identifiers with the strengths, respectively, and to create a list including the identifiers sorted in an order of the strengths,
wherein the controller compares an nth list created by the list creating unit based on the nth (n>1) scanning result with an (n−k)th list created based on the (n−k)th (n>k≧1) scanning result, and
wherein, when a number of orders of nth identifiers in the nth list which are identical to orders of the identified (n−k)th identifiers in the (n−k)th list is a predetermined number or more, the controller sets the specific period from the nth scanning to the (n+1)th scanning to be longer than the period from the (n−k)th scanning to the (n−k+1)th scanning.

5. The mobile communication terminal of claim 4,
wherein, when a number of orders of the identified nth identifiers in the nth list which are identical to orders of the identified (n−k)th identifiers in the (n−k)th list is the predetermined number or more, if the specific period is to be longer than a upper limit period, the controller sets the upper limit period as the specific period.

6. The mobile communication terminal of claim 2,
wherein, when a number of orders of the identified first identifiers in the first list which are identical to orders of the identified previous identifiers in the previous list is less than the predetermined number, the controller sets an initial value as the specific period.

7. The mobile communication terminal of claim 6,
wherein the list creating unit creates the list including only access points, of which a strength of a signal is a predetermined strength or more.

8. A method of controlling a wireless communication using any one of a plurality of access points, the method comprising:
performing a scanning periodically to receive a signal including an identifier from respective access points;
determining, for each of the respective access points, a strength of the signal received from the access point,
associating the identifiers with the strengths, respectively;
creating a list in which the identifiers are sorted in an order of the strengths;
comparing a first list containing a set of two or more first identifiers created based on the first scanning result with a previous list containing a set of two or more previous identifiers created based on previous scanning results before the first scanning; and
setting a specific period, as a period from the first scanning to a second scanning performed after the first scanning, to be longer than a previous period from the previous scanning to the first scanning, when at least a predetermined number of first identifiers are included among the set of previous identifiers while the set of first identifiers is not the same as the set of previous identifiers.

9. The method of controlling a wireless communication of claim 8, wherein
when a number of orders of the identified first identifiers in the first list which are identical to orders of the identified previous identifiers in the previous list is a predetermined number or more and when a difference between the strengths of the first identifiers on the first scanning and the strengths of the previous identifiers, which are identified to any of the first identifiers, on the previous scanning is within a predetermined range, the controller sets the specific period from the first scanning to the second scanning to be longer than the previous period from the previous scanning to the first scanning, and
the specific period is set based on when a rate of access points corresponded with each other is equal to or larger than a rate representing a predetermined rate of the access points in the lists.

10. The mobile communication terminal of claim 1, wherein
the scanning unit obtains a strength of the signal received from the access point,
the scanning unit includes a list creating unit configured to associate the identifiers with the strengths, respectively, and to create a list including the identifiers sorted in an order of the strengths,
the controller compares a first list created by the list creating unit based on the first scanning result with a previous list created based on previous scanning results before the first scanning,
when a number of orders of the identified first identifiers in the first list which are identical to orders of the identified previous identifiers in the previous list is a predetermined number or more and when a difference between the strengths of the first identifiers on the first scanning and the strengths of the previous identifiers, which are identified to any of the first identifiers, on the previous scanning is within a predetermined range, the controller sets the specific period from the first scanning to the second scanning to be longer than the previous period from the previous scanning to the first scanning, and
the specific period is set based on when a rate of access points corresponded with each other is equal to or larger than a rate representing a predetermined rate of the access points in the lists.

11. The mobile communication terminal of claim 3, wherein
the scanning unit detects a strength of the signal received from the access point,
the scanning unit includes a list creating unit configured to associate the identifiers with the strengths, respectively, and to create a list in which the identifiers are sorted in an order of the strengths, and
the controller compares a list created by the list creating unit based on the nth (n>1) scanning result with a list created based on the (n−k)th (n>k≧1) scanning result,
when a number of orders of the identified nth identifiers in the nth list which are identical to orders of the identified (n−k)th identifiers in the (n−k)th list is a predetermined number or more, and when a difference between the strengths of the nth identifiers on the nth scanning and the strengths of the (n−k)th identifier, which are identified to any of the nth identifiers, on the previous scanning is within a predetermined range, the controller sets the specific period from the nth scanning to the (n+1)th scanning to be longer than the period from the (n−k)th scanning to the (n−k+1)th scanning, and
the specific period is set based on when a rate of access points corresponded with each other is equal to or larger than a rate representing a predetermined rate of the access points in the lists.
